(19) United States
(12) Patent Application Publication
(10) Pub. No.: US 2007/0139815 A1
(43) Pub. Date: Jun. 21, 2007

(54) DISK DRIVE DEVICE

(75) Inventors: Tomonao Takamatsu, Minato-ku, Tokyo (JP); Biswas Debasish, Minato-ku, Tokyo (JP); Katsumi Hisano, Minato-ku, Tokyo (JP); Hideo Iwasaki, Minato-ku, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/608,869

(22) Filed: Dec. 11, 2006

(30) Foreign Application Priority Data
Dec. 12, 2005 (JP) 2005-358138

(51) Int. Cl. G11B 5/012

(52) U.S. Cl. 360/97.01

(57) ABSTRACT

A carriage arm has a movement locus and supports a head that performs either one of recording information to a disk and reproducing information recorded on the disk. A carriage driving mechanism moves the carriage arm in a radial direction of the disk to perform a positioning of the carriage arm. A guide member changes a direction of air flowing on at least one of a peripheral portion of the disk and a neighboring portion of the peripheral portion toward a center portion of the disk. The guide member is provided in a position where the movement locus of the carriage arm is not blocked in an area of either one of the peripheral portion and the neighboring portion.

CROSS-REFERENCE TO RELATED APPLICATIONS

This application is based upon and claims the benefit of priority from the prior Japanese Patent Application No. 2005-358138, filed on Dec. 12, 2005; the entire contents of which are incorporated herein by reference.

### BACKGROUND OF THE INVENTION

1. Field of the Invention The present invention relates to a technology for enhancing precision of head positioning in a disk drive device.

2. Description of the Related Art Recently, technologies for information processing have been rapidly improved and it has been increasingly required to make recording density of a recording medium (disk) higher and make recording speed of the recording medium faster in a hard disk drive (HDD). Accordingly, it is critical to assure an accuracy of positioning of a recording head used for recording data on the recording medium.

However, because the disk is rotated at a high speed in a narrow space of the disk drive device, an airflow is generated and maximum airflow speed becomes more than a few dozen m/s in some areas of inside of the disk drive device. Therefore, an air turbulence occurred inside of the disk drive device largely affects the accuracy of the head positioning.

To solve the problems described above, each of components in the disk drive device has been modified for preventing the air turbulence from occurring. Nevertheless, because the recording speed is still becoming faster and the recording density is still becoming higher, it is required to reduce the occurrence of the air turbulence and to improve the accuracy of the head positioning.

A technology for improving the accuracy of the head positioning is disclosed in, for example, JP-A 2004-185666 (KOKAI), by installing a circular-shaped air straightening vane at a position substantially parallel to a surface of a disk for preventing a fluttering of the disk called “disk flutter”.

Further, JP-A2004-171674 (KOKAI) discloses a technology for preventing an air turbulence generated along the surface of the disk by using an air straightening vane integrated to a ramp member.

According to a result of a numeric analysis on an airflow speed, a speed of airflow generated from a rotating disk becomes maximum speed on a circular arc of the periphery of the disk. The air flows across a carriage arm and the recording head supported by the carriage arm, when the carriage arm with the recording head performs reading and writing data on the periphery of the disk. In other words, due to a hydrodynamic force of the airflow, the carriage arm that supports the recording head becomes to flatter when the carriage arm with the recording head performs reading and writing data on the periphery of the disk.

However, with the technologies disclosed in the above literatures, it is difficult to prevent the airflow from causing the flattering of the carriage arm.

### SUMMARY OF THE INVENTION

A disk drive device according to one aspect of the present invention includes a disk on which information is recorded, the disk being rotated by a motor; a case that accommodates the disk; a carriage arm , having a movement locus, that supports a head that performs either one of recording information to the disk and reproducing information recorded on the disk; a carriage driving mechanism that moves the carriage arm in a radial direction of the disk to perform a positioning of the carriage arm; and a guide member that changes a direction of air flowing on at least one of a peripheral portion of the disk and a neighboring portion of the peripheral portion toward a center portion of the disk. The guide member is provided in a position where the movement locus of the carriage arm is not blocked in an area of either one of the peripheral portion and the neighboring portion.

### BRIEF DESCRIPTION OF THE DRAWINGS

FIG. 1 is a top view for explaining an inside of an HDD according to a first embodiment of the present invention;

FIG. 2 is a cross section of the HDD taken along a line A-B of FIG. 1;

FIG. 3 is a schematic for explaining a guide member provided on an internal wall of the HDD shown in FIG. 1;

FIG. 4 is a conceptual perspective view of the guide member shown in FIG. 3;

FIG. 5 is a schematic for explaining the guide member shown in FIG. 3, which changes a direction of airflow;

FIG. 6 is a schematic for explaining an HDD according to a second embodiment of the present invention;

FIG. 7 is a schematic for explaining a guide member shown in FIG. 6, which changes a direction of airflow;

FIG. 8 is a schematic for explaining a distribution of an airflow speed when a disk rotates in an HDD in which the guide member shown in FIG. 6 is not provided;

FIG. 9 is a schematic for explaining a distribution of the airflow speed when the disk rotates in the HDD that includes the guide member shown in FIG. 6;

FIG. 10 is a schematic for explaining an HDD according to a third embodiment of the present invention; and

FIG. 11 is a cross section of the HDD taken along a line C-D of FIG. 10.

### DETAILED DESCRIPTION OF THE INVENTION

Exemplary embodiments of the present invention are explained below in detail with reference to the accompanying drawings. The present invention is not limited to the embodiments explained below. As an example of a disk drive device according to the present embodiments, an HDD will be explained.

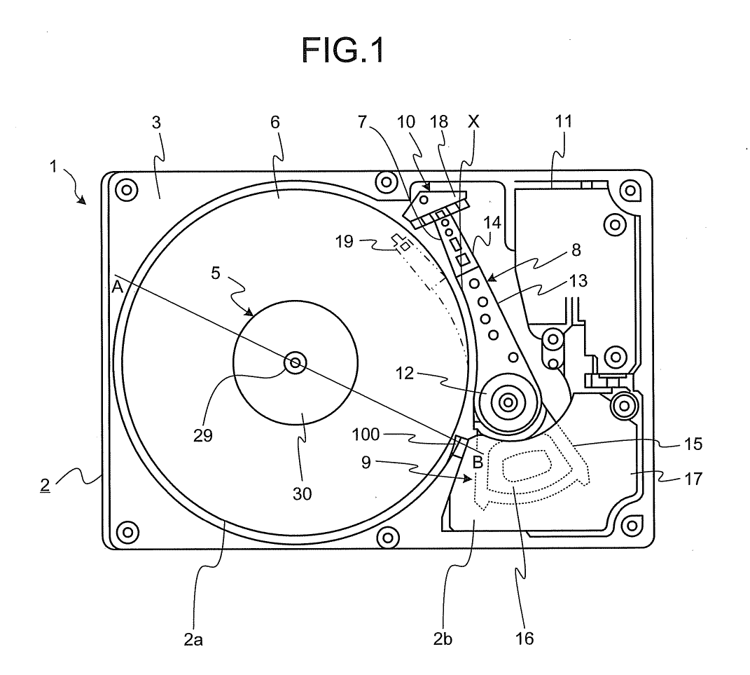

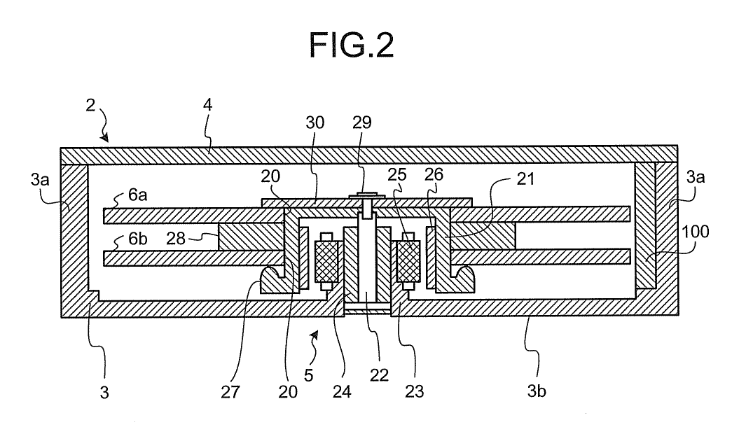

As shown in FIG. 1 and FIG. 2, an HDD 1 according to a first embodiment includes a magnetic disk 6 (two magnetic disks 6a and 6b according to the present embodiments), which is a storage medium provided in a case 2, a spindle motor 5 that supports and rotates the magnetic disk 6, a carriage assembly 8 that supports a magnetic head portion 7, a voice coil motor (VCM) 9 that drives the carriage assembly 8, and a board unit 11.

The case 2 includes a circular-shaped inner wall 3a formed in a substantially same shape of the magnetic disk 6, a rectangular-box-shaped base 3 which top surface is open, and a top cover 4 that is screwed down with screws to the base 3 to close the opening top surface of the base 3. In the case 2, the spindle motor 5 provided on a bottom portion 3b of the base 3 and the two magnetic disks 6a and 6b that are supported and rotated by the spindle motor 5 are installed.

The inner wall 3a is formed in a circular arc shape concentric with a circular arc of the periphery of the magnetic disks 6a and 6b, having a radius longer than a radius of the circular arc of the periphery of the magnetic disks 6a and 6b, and covers the periphery of the magnetic disks 6a and 6b. A guide member 100 is provided on the inner wall 3a on a position near a shaft bearing 12 and where a movement locus of a carriage arm 13 is not blocked.

The guide member 100 is provided for changing a direction of air flowing on a peripheral portion of the magnetic disk 6 and a neighboring portion of the peripheral portion of the magnetic disk 6, toward a center portion of the magnetic disk 6, when the magnetic disk 6 is rotating.

In the case 2, such assemblies are installed as the magnetic head portions 7 for recording and reproducing information to and from the magnetic disks 6a and 6b, the carriage assembly 8 that movably supports the magnetic head portions 7 for the magnetic disks 6a and 6b, the VCM 9 included in a carriage driving mechanism that rotates the carriage assembly 8 in a radial direction of the magnetic disks 6a and 6b and performs a positioning of the carriage assembly 8, a ramp loading mechanism 10 that holds the magnetic head portions 7 in a save area separated from the magnetic disks 6a and 6b, when the magnetic head portions 7 move to the last periphery of the magnetic disks 6a and 6b, and the board unit 11 that includes a preamplifier.

In other words, the case 2 includes a disk storing unit 2a that stores the magnetic disks 6a and 6b, and a carriage storing unit 2b that stores the carriage assembly 8. As for the base 3 in the case 2, there is a portion X where the inner wall 3a is not provided so that the carriage assembly 8 is to be inserted above the surface of the magnetic disks 6a and 6b. The portion X that excludes the inner wall 3a is arranged around a boundary area between the disk storing unit 2a and the carriage storing unit 2b.

On an outer surface of the bottom portion 3b of the base 3, the spindle motor 5, the VCM 9, and a print circuit board that controls a movement of the magnetic head portions 7 are screwed down through the board unit 11, although the configuration is not shown.

As shown in FIG. 1 and FIG. 2, the carriage assembly 8 includes the shaft bearing 12 that is fixed on the bottom portion 3b of the base 3 and the carriage arms 13 elongated from the shaft bearing 12. The carriage arms 13 are arranged parallel to each of the surfaces of the magnetic disks 6a and 6b with a predetermined space kept between each of the carriage arms 13 and each of the magnetic disks 6a and 6b, and elongated to the same direction from the shaft bearing 12. The carriage assembly 8 includes elongated-plate-shaped suspensions 14 that are elastically deformable. The suspensions 14 are made with a blade spring and each of end portions of the suspensions 14 is fixed to each of end portions of the carriage arms 13 by spot welding or adhesion, to be elongated from the carriage arms 13. Each of the suspensions 14 can be integrally formed with each of the corresponding carriage arms 13. At each of elongated end portions of the suspensions 14, the magnetic head portions 7 are provided.

Each of the magnetic head portions 7 includes a substantially rectangular-shaped slider (not shown) and a magneto-resistance (MR) head (not shown) formed on the slider and used for recording and reproducing data, and is fixed to a gimbal portion (not shown) formed at the end portion of each of the suspensions 14. Each of the four magnetic head portions 7 attached to each of the suspensions 14 is arranged so that each two of the magnetic head portions 7 face each other to sandwich each of the magnetic disks 6a and 6b from both side surfaces of each of the magnetic disks 6a and 6b.

The carriage assembly 8 includes a support shaft 15 elongated from the shaft bearing 12 toward a direction opposite to the carriage arm 13. With the support shaft 15, a voice coil 16 that structures a part of the VCM 9 is supported. The support shaft 15 is made of synthetic resin and integrally arranged on the periphery of the voice coil 16. The voice coil 16 is arranged between a pair of yokes 17 fixed on the base 3, and structures the VCM 9 with the yokes 17 and a magnet (not shown) fixed to one of the yokes 17. Through a power distribution to the voice coil 16, the carriage assembly 8 rotates around the shaft bearing 12 and the magnetic head portions 7 move on a desired track of the magnetic disks 6a and 6b to perform a positioning.

The ramp loading mechanism 10 is provided on the bottom portion 3b of the base 3 and includes a ramp 18 arranged outside of the magnetic disks 6a and 6b and a tab 19 elongated from each of the end portions of the suspensions 14. When the carriage assembly 8 rotates and the magnetic head portions 7 move to the save area arranged outside of the magnetic disks 6a and 6b, each of the tabs 19 is to be engaged with a ramp surface formed on the ramp 18, pulled up by the slope of the ramp surface, and unloads the magnetic head portions 7.

Each of the magnetic disks 6a and 6b is formed in a circular shape having a diameter of, for example, 65 millimeter (2.5 inch), and includes an inner opening portion 20 and magnetic recording layers on the top and bottom surfaces of each of the magnetic disks 6a and 6b. The spindle motor 5 includes a hub 21 that performs a function as a rotor, and the two magnetic disks 6a and 6b are concentrically engaged with the hub 21 and laminated with a predetermined space between the magnetic disks 6a and 6b along an axial direction of the hub 21. The magnetic disks 6a and 6b are driven by the spindle motor 5 and rotate with the hub 21 at a predetermined speed.

The hub 21 of the spindle motor 5 is formed in a cylindrical shape which upper end portion is closed. In the hub 21, a spindle shaft 22 is concentrically and integrally arranged with the hub 21. A cylindrical portion 23 is integrally formed on the bottom portion 3b of the base 3, projected toward inside of the case 2, and a shaft bearing 24 is engaged with an inner periphery of the cylindrical portion 23. The spindle shaft 22 is inserted in the shaft bearing 24 and rotatably supported by the shaft bearing 24. Accordingly, the hub 21 is arranged on a predetermined position inside of the case 2. A stator 25 is provided on a peripheral portion of the shaft bearing 24 and a magnet 26 is concentrically arranged on an inner peripheral portion of the hub 21 so that the magnet 26 faces to the stator 25 with a space kept between the magnet 26 and the stator 25.

A flange-shaped disk bearing portion 27 is formed on the bottom side of the periphery of the hub 21. The two magnetic disks 6a and 6b are engaged with a peripheral surface of the hub 21 that is inserted in the inner opening portion 20 of the magnetic disks 6a and 6b, and laminated on the disk bearing portion 27.

A spacer ring 28 is engaged with the periphery of the hub 21 and laminated in a space sandwiched by the magnetic disks 6a and 6b. A disk damper 30 is screwed down with a screw 29 on the top surface of the hub 21. A peripheral portion of the disk damper 30 has contact with a center portion of the top surface of the magnetic disk 6a laminated at an upper stage to push the two magnetic disks 6a and 6b and the spacer ring 28 toward the disk bearing portion 27 of the hub 21. Accordingly, the magnetic disks 6a and 6b and the spacer ring 28 are sandwiched by the disk bearing portion 27 and the disk damper 30, to be fixed to the hub 21, with a close contact with each other. The disk damper 30 rotates together with the hub 21 and the magnetic disks 6a and 6b in an integrated manner.

With the configuration, the magnetic disks 6a and 6b are rotated at a high speed by using the spindle motor 5, the carriage assembly 8 (carriage arm 13) having the magnetic head portions 7 is rotated in a radial direction of the magnetic disks 6a and 6b by using the VCM 9, to perform a positioning, data is read from and written to the magnetic disks 6a and 6b by the magnetic head portions 7.

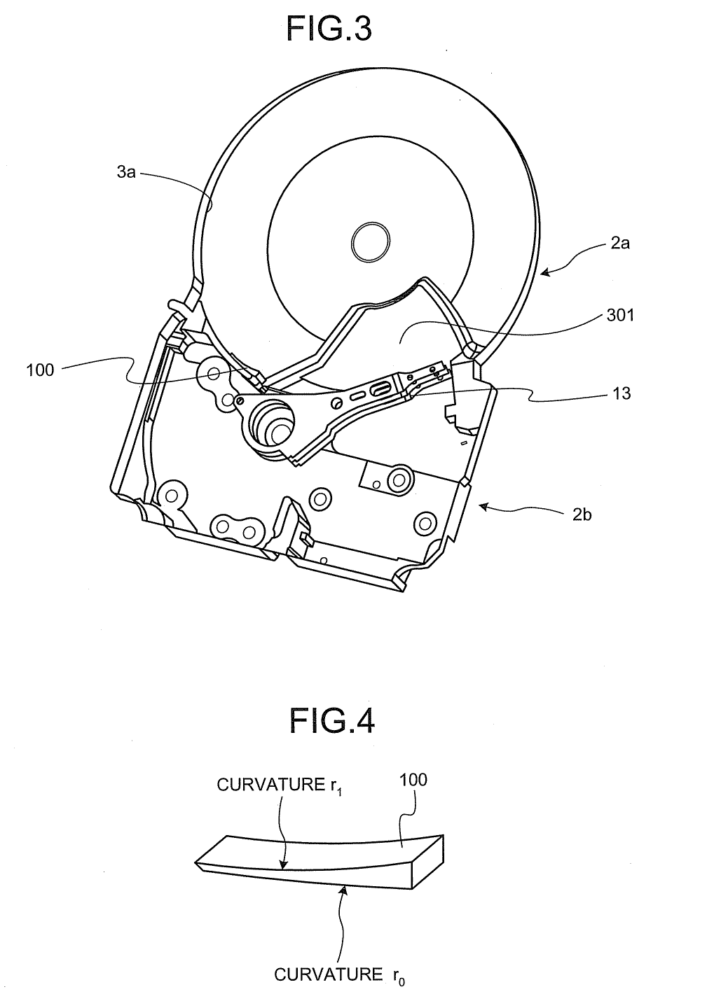

As shown in FIG. 3, the inner wall 3a having a circular arc with a curvature smaller than a curvature of the magnetic disk 6 is formed on the base 3 of the HDD 1, along the peripheral portion of the magnetic disk 6. Naturally, the inner wall 3a is not formed in an area corresponding to a movement locus on which the carriage arm 13 moves. A predetermined space is arranged between the inner wall 3a and the peripheral portion of the magnetic disk 6 and the guide member 100 is provided in the predetermined space.

As shown in FIG. 3, in the area corresponding to the movement locus of the carriage arm 13, arranged inside of the base 3, a concave portion 301 is formed from the inside of the base 3 to the outside of the base 3 for assuring a space in which the carriage arm 13 moves. Accordingly, the carriage arm 13 can move in the base 3 for reading and writing data from and to the magnetic disk 6.

The guide member 100 is arranged on a position near the concave portion 301 of the base 3 close to the shaft bearing 12 on the inner wall 3a, ahead of the carriage arm 13 along a direction of disk rotation. In other words, the guide member 100 is arranged on a position as close as possible to the carriage arm 13 and where the movement of the carriage arm 13 is not blocked. Because the guide member 100 is arranged ahead of the carriage arm 13 along the direction of disk rotation, it becomes possible to change a direction of air flowing on the peripheral portion of the magnetic disk 6 and a neighboring portion of the peripheral portion of the magnetic disk 6, which flows on a path across the carriage arm 13 when the magnetic disk 6 rotates, so that the airflows toward the center portion of the magnetic disk 6.

As shown in FIG. 4, the guide member 100 includes a surface having a curvature represented as r₀ inscribed in the inner wall 3a and a guide surface having a curvature represented as r₁, which is closely in contact with the magnetic disk 6. The curvature r₁ of the guide surface can be arbitral if the curvature r₁ , becomes larger than the curvature r₀ of the surface inscribed in the inner wall 3a. The guide member 100 is arranged on the inner wall 3a so that the guide surface and the surface of the inner wall 3a ahead of the guide member 100 along the direction of disk rotation make a continuous surface.

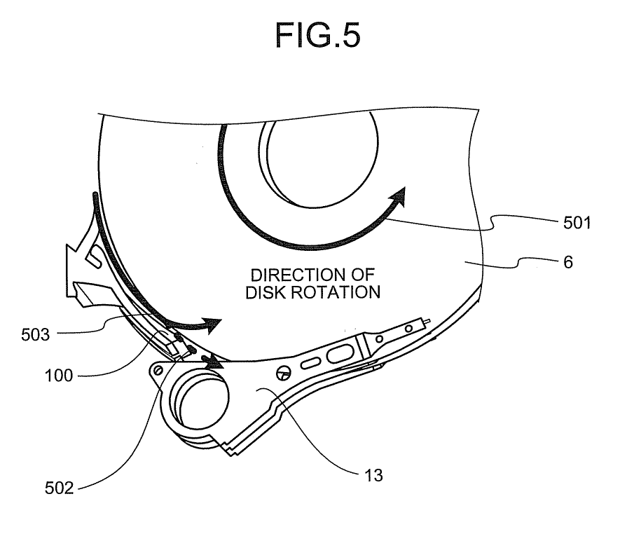

As shown in FIG. 5, by rotating the magnetic disk 6 at a high speed, airflow is generated along a disk rotation direction 501. With a conventional HDD that does not have the guide member 100, air has been flown along a direction shown with a dotted-line arrow 502, on the peripheral portion of the magnetic disk 6 and the neighboring portion of the peripheral portion of the magnetic disk 6.

On the contrary, the HDD 1 can change a direction of the airflow along the inner wall 3a on the peripheral portion of the magnetic disk 6 and the neighboring portion of the peripheral portion of the magnetic disk 6, so that the air flows toward the center portion of the magnetic disk 6 by guiding the air to flow along the guide surface of the guide member 100. In other words, in FIG. 5, a direction of the air flowing along a direction of disk rotation is changed to a direction 503 that is toward the center portion of the magnetic disk 6. Thus, because the guide member 100 having a shape described above is provided in the HDD 1, it becomes possible to effectively change a direction of the airflow toward the center portion of the magnetic disk 6, when the magnetic disk 6 rotates.

A speed of the airflow generated when the magnetic disk 6 rotates becomes faster and faster from an inner peripheral portion to an outer peripheral portion of the magnetic disk 6. Accordingly, if the direction of the air flowing on the peripheral portion of the guide member 100 is changed toward the center portion of the magnetic disk 6, with a hydrodynamics of the airflow which direction has been changed toward the center portion of the magnetic disk 6, a direction of air flowing on the inner peripheral portion of the magnetic disk 6 is also changed toward the center portion of the magnetic disk 6.

As a result, it becomes possible to largely reduce a flow speed of the air flowing across the carriage arm 13 moving for reading and writing data from and to the magnetic disk 6. According to the numeric hydrodynamic analysis, it was proved that more than 10% of the flow speed of the air flowing across the carriage arm 13 can be reduced by providing the guide member 100.

As described, according to the present embodiments, the guide member 100 is provided in a position just before where the flowing air comes across the carriage arm 13 when the magnetic disk 6 rotates. It is because a direction of the airflow, which flow speed is made fastest after the air flew a circuit of the magnetic disk 6 along the inner wall 3a, is changed toward the center portion of the magnetic disk 6. With the guide member 100 provided on such a position, it becomes possible to effectively reduce the flow speed of the air flowing across the carriage arm 13.

With the HDD 1 according to the present embodiments, a position for providing the guide member 100 is not limited to the position explained above, and other positions can be acceptable if the direction of the air flowing on the peripheral portion of the magnetic disk 6 and the neighboring portion of the peripheral portion of the magnetic disk 6 can be changed toward the center portion of the magnetic disk 6. It is because, if the direction of the air flowing ahead of the carriage arm 13 along the direction of disk rotation can be changed toward the center portion of the magnetic disk 6, flow speed of the air flowing across the carriage arm 13 can be reduced.

Because the guide member 100 in the HDD 1 changes the direction of the air flowing on the peripheral portion of the magnetic disk 6 and the neighboring portion of the peripheral portion of the magnetic disk 6 toward the center portion of the magnetic disk 6, the flow speed of the air flowing across the carriage arm 13 is reduced, resulting in reducing a hydrodynamic fore of the air flowing across the carriage arm 13. Accordingly, fluttering of the carriage arm 13 is reduced and accuracy of the head positioning of the magnetic head portions 7 supported by the carriage arm 13 can be improved.

The present embodiments are not limited to the embodiments described above, and various modifications exemplary explained below can be acceptable.

An example of the modification of the first embodiment has a configuration such that the guide member 100 and the inner wall 3a of the base 3 are integrally formed. Accordingly, an HDD according to the modification includes a projection portion having a high curvature similar to the guide member 100, on the inner wall 3a.

With the projection portion having the high curvature formed on the inner wall 3a, it is possible to change the direction of the airflow toward the center portion of the magnetic disk 6. In other words, it is possible to achieve the same effect as that explained with the first embodiment. Further, by integrally forming the base 3 and the guide member 100, it becomes possible to reduce an operation procedure for setting up the HDD. The guide member to be explained below with other embodiments can also be integrally formed with the base 3.

According to the first embodiment, the shape of the guide member is not limited to the shape that includes a surface having a curvature higher than the curvature of the inner wall of the case. According to a second embodiment, an example including a guide member having a shape different from the shape explained in the first embodiment will be explained.

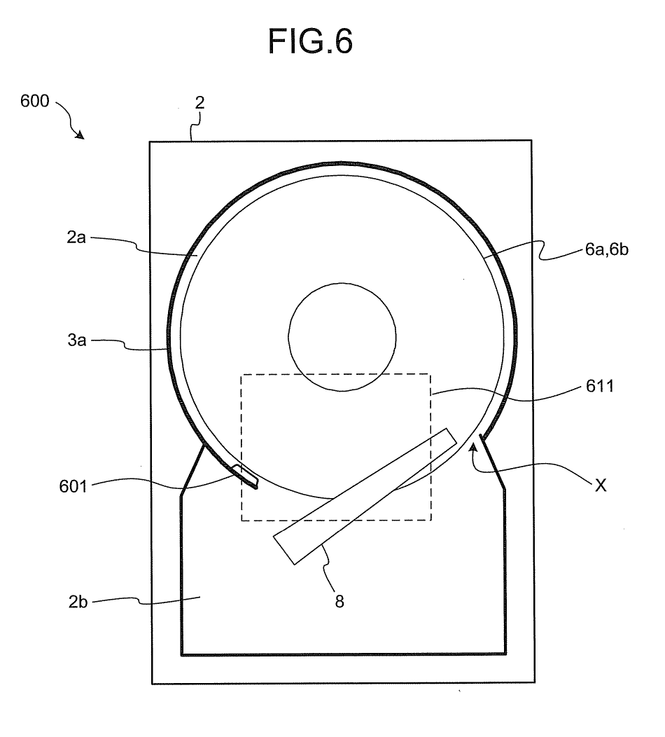

As shown in FIG. 6, a guide member 601 is arranged on the same position in an HDD 600 according to the second embodiment, as the position of the guide member 100 explained in the first embodiment, and only the shape of the guide member 601 is different from the shape of the guide member 100. In the configuration of the HDD 600, same components explained with the HDD 1 of the first embodiment will be represented with the same reference numerals and explanations thereof will be omitted.

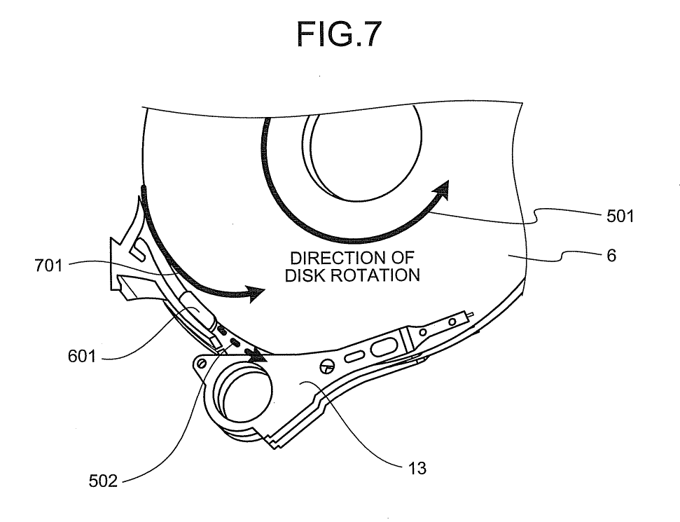

A shape of the guide member 601 shown in FIG. 7 can be arbitral if it is possible to change the direction of the airflow toward the center portion of the disk. For example, according to the second embodiment, the shape is in a convex shape which projected portion is toward the center portion of the magnetic disk 6.

When the magnetic disk 6 rotates, air flowing along a direction of disk rotation on the peripheral portion of the magnetic disk 6 and the neighboring portion of the peripheral portion of the magnetic disk 6 collides to the guide member 601. Because the guide member 601 is formed in the convex shape, the collided airflow is to be guided to flow toward the center portion of the magnetic disk 6 along a direction 701. As a result, a speed of the airflow on the peripheral portion of the magnetic disk 6 and the neighboring portion of the peripheral portion of the magnetic disk 6 can be reduced. Next, a result of the numeric hydrodynamics analysis of the airflow speed will be explained.

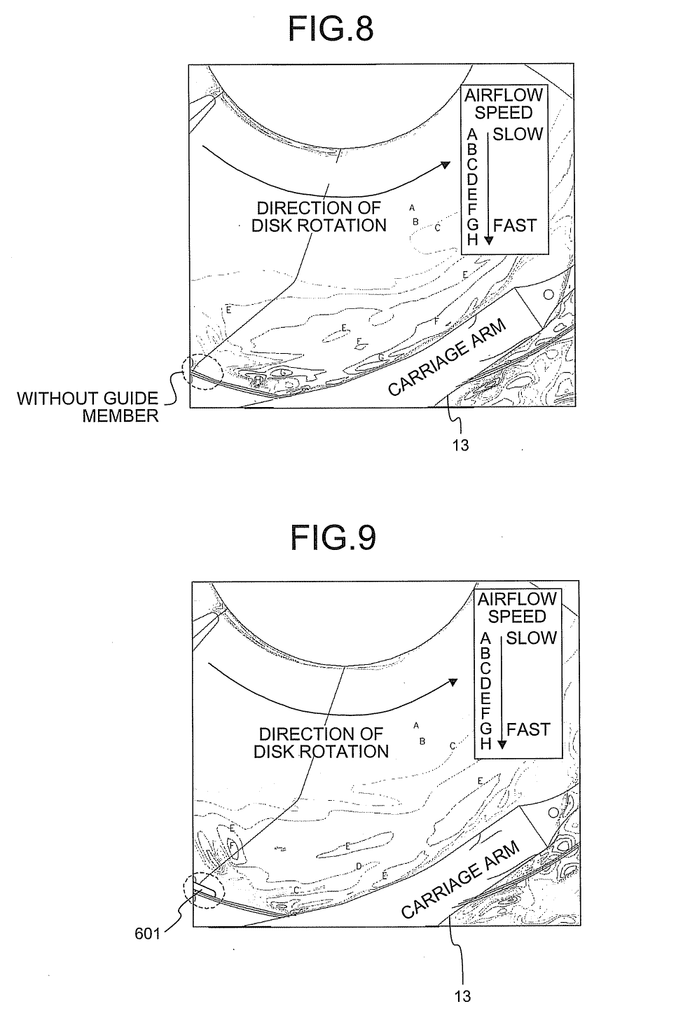

As shown in FIG. 8, if the guide member is not provided, flow speeds represented with “F” and “G” is spread in areas near the carriage arm 13. In FIG. 8, the flow speed is represented with an alphabetical order from “A” to “H”, with which the flow speed is gradually changed from the slowest rate represented with “A” to the fastest rate represented with “H”.

On the contrary, as shown in FIG. 9, if the guide member is provided, the flow speed represented with “D” and “F” is spread in the areas near the carriage arm 13. The flow speed is represented with the same alphabetical order shown in FIG. 8.

With a comparison between the results shown in FIG. 8 and FIG. 9, it is proved that the flow speed near the carriage arm 13 was overall reduced by providing the guide member 601. According to the numeric data obtained from a result of the numeric hydrodynamic analysis, more than 20% of the maximum flow speed near the carriage arm 13 was reduced. Thus, because the airflow speed near the carriage arm 13 is reduced, the fluttering of the carriage arm 13 is also reduced.

Although only one guide member 601 is provided according to the second embodiment, it is possible to provide a plurality of the guide members 601 ahead of the carriage arm 13 along the direction of disk rotation. Even when the guide members 601 are provided, because each of the guide members 601 can change the direction of the airflow toward the center portion of the magnetic disk 6, the speed of airflow along the direction of disk rotation can be reduced.

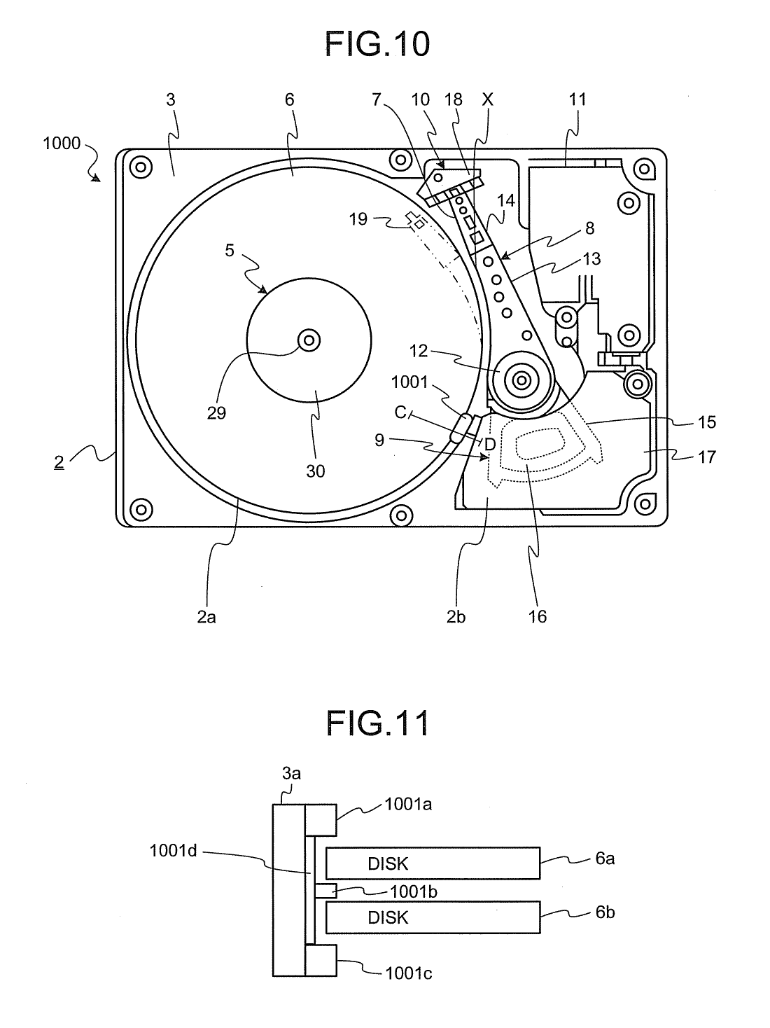

As shown in FIG. 10, an HDD 1000 according to a third embodiment is different from the HDD 1 of the first embodiment in that the guide member 100 of the HDD 1 is changed to a guide member 1001. In the configuration of the HDD 1000, same components explained with the HDD 1 of the first embodiment will be represented with the same reference numerals and explanations thereof will be omitted.

A space is provided between the two magnetic disks 6a and 6b, so that the carriage arm 13 having each of the magnetic head portions 7 can move in the space. In the space, airflow is generated when the magnetic disks 6a and 6b rotate, resulting in causing the carriage arm 13 to flutter.

According to the third embodiment, in the area where the carriage arm 13 of the HDD 1000 can move, the guide member 1001 is provided in a shape having projected portions above and below the surface of the magnetic disks 6a and 6b.

As shown in FIG. 11, portions 1001a, 1000b, and 1000c of the guide member 1001 are projected above and the below the surface of the magnetic disks 6a and 6b. The portions 1000a, 1000b, and 1001c of the guide member 1001 can effectively reduce the speed of air flowing across the carriage arm 13 that moves in corresponding areas such as an area above the magnetic disk 6a, an area between the magnetic disks 6a and 6b, and an area below the magnetic disk 6b. Because the guide portions 1000a, 1001b, and 1001c are projected toward the magnetic disks 6a and 6b, a portion of each peripheral portion of the magnetic disks 6a and 6b is sandwiched by the guide portions 1001a, 1001b, and 1001c, from both surfaces of each of the magnetic disks 6a and 6b. With this arrangement, it becomes possible to realize the same effect as that obtained by the air bearing, resulting in preventing a fluttering phenomenon in which the magnetic disks 6a and 6b flutter.

A length of the portion 1001b of the guide member 1001, which is projected toward the magnetic disk 6, is required such that the portion 1001b does not affect to set up the HDD 1000.

The guide member 1001 includes a portion 1001d arranged to become contact with the inner wall 3a near the peripheral portion of the magnetic disk 6. The portion 1001d of the guide member 1000 can change the direction of air flowing outside the peripheral portion of the magnetic disk 6 toward the center portion of the magnetic disks 6a and 6b. Accordingly, the speed of the air flowing across the carriage arm 13 can be reduced.

The present invention is not limited to the above explained embodiments and can be modified within the scope and the spirits of the present invention. For example, according to the present embodiments, the HDD that drives the magnetic disk is explained as an example of the disk drive device. However, the present invention is not thus limited and can be applied to other disk drive devices that drive a disk.

As described above, according to an embodiment of the present invention, the disk drive device is suitable to improve a casing of the disk drive device, and particularly, suitable when the disk rotates at a high speed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive device comprising:
a disk on which information is recorded, the disk being rotated by a motor;
a case that accommodates the disk;
a carriage arm, having a movement locus, that supports a head that performs either one of recording information to the disk and reproducing information recorded on the disk;
a carriage driving mechanism that moves the carriage arm in a radial direction of the disk to perform a positioning of the carriage arm; and
a guide member that changes a direction of air flowing on at least one of a peripheral portion of the disk and a neighboring portion of the peripheral portion toward a center portion of the disk, the guide member being provided in a position where the movement locus of the carriage arm is not blocked in an area of either one of the peripheral portion and the neighboring portion.

2. The device according to claim 1, wherein
the case includes an inner wall that has a curvature smaller than a curvature of the periphery of the disk and is arranged in an area outside of the periphery of the disk and outside of the movement locus of the carriage arm, along the periphery of the disk; and
a portion of the guide member is projected from the inner wall.

3. The device according to claim 2, wherein
the guide member includes a guide surface that faces the disk, the guide member having a curvature larger than the curvature of the inner wall and making a continuous surface with a surface of the inner wall at an upstream of the guide member along a direction of rotation of the disk.

4. The device according to claim 2, wherein
the guide member is provided at a neighboring position of a rotation shaft for rotating the carriage arm included in the carriage mechanism at an upstream of the carriage arm along a direction of rotation of the disk.

5. The device according to claim 1, wherein
the guide member is formed in a convex shape with a projected portion toward a center of the disk.

6. The device according to claim 1, wherein
a part of the guide member is extended along a surface of the disk.

7. The device according to claim 6, wherein
the guide member is extended in an area arranged for moving the carriage arm between the disks.

8. The device according to claim 1, wherein
the guide member is integrally formed with an inner wall provided along the disk.
